(19) United States
(12) Patent Application Publication
(10) Pub. No.: US 2021/0037936 A1
(43) Pub. Date: Feb. 11, 2021

(54) LUGGAGE TRANSPORTATION SYSTEM

(71) Applicant: Abdullah C. Erdal, Santa Clara, CA (US)

(72) Inventor: Abdullah C. Erdal, Santa Clara, CA (US)

(21) Appl. No.: 16/969,157

(22) PCT Filed: Feb. 10, 2019
(86) PCT No.: PCT/US2019/017402

§ 371 Date: Aug. 11, 2020

Related U.S. Application Data
(60) Provisional application No. 62/629,617, filed on Feb. 12, 2018.

(51) Int. Cl. A45C 9/00; A45C 5/14

(52) U.S. Cl. CPC A45C 9/00; A45C 2009/005; A45C 5/14

(57) ABSTRACT

A system is configured to transport a person along with luggage by providing a foldable, slidable, or otherwise collapsible, platform as part of a luggage-transportation system, with the platform configured to hold a person moving with the luggage. The system comprises a container configured to receive content such as apparel, a handle coupled to the container, and a platform with at least one wheel. The platform is movably coupled to the container at an edge proximal to the container such that, when moved into an open configuration, the platform is suitable for holding a standing person.

### CROSS REFERENCE TO RELATED APPLICATION

This application claims the benefit of U.S. Provisional Patent Application No. 62/629,617, filed Feb. 12, 2018, which is incorporated herein in its entirety.

### FIELD OF THE INVENTION

The present invention relates to a system for transporting luggage. More particularly, the present invention relates to luggage that is configured to transport a person along with the luggage by providing a foldable, slidable, or otherwise collapsible, platform as part of a luggage-transportation system, with the platform configured to hold a person moving with the luggage. For the purposes of the present invention, the term luggage can be any container configured to contain a user's clothing, documents, personal effects, or any other object that is traditionally carried by a person. Types of luggage can include a suitcase, briefcase, backpack, or any other container that is sized for travel.

### BACKGROUND

Most luggage, especially luggage used for travel on airplanes, busses, and trains, includes wheels allow the luggage to be pushed or pulled by a person, thus relieving the use of the need to carry the luggage to move it from point A to point B. But over time, airports and other transportation stations have grown, forcing the user to walk next to the luggage, sometimes for great distances.

FIG. 1 is a perspective view of an example of the prior-art. In this drawing, the luggage includes a container 1 to receive and hold contents such as apparel, clothing or other articles to be transported. The luggage can be hand held and carried by handle 2. Alternatively, handle 2 can extend or telescope outward from the container to allow the user to direct the luggage in a predetermined direction as it is rolled, using wheels 10. Whether carried or rolled, however, the person must walk with the luggage, sometimes for great distances.

To alleviate the need to walk distances while pushing or pulling wheeled luggage, systems have developed to allow person to ride along with the luggage. For example, systems like manual and motorized scooters exist to carry luggage along with its owner. These systems, however, are complicated, add great weight to the luggage, are difficult to use, and expensive to manufacture. They are manufactured distinct from the luggage they carry, or otherwise separate the luggage and the person from the system of transport. This separation forces the luggage to have less volume than it otherwise would, limiting the content it can carry. In addition, current solutions tend to use more space when folded up for storage. Finally, current non-integrated solutions can be dangerous, providing failure points for causing the system to collapse and injure the user.

Thus, a need exists (i) to provide luggage that can transport itself and a person on wheels, either standing or sitting, manually or with a motor, (ii) to maintain or increase such luggage's content volume as close as possible to the maximum allowed by airlines and other transportation systems, and (iii) to provide for simplicity of use, compact storage, and cost-effective manufacturing, and (iv) to be generally safer than other products by providing a stronger and more practical integrated solution.

### SUMMARY OF THE INVENTION

Embodiments of the present invention provide an integrated solution for transporting both luggage and people. Exemplary embodiments of the present invention that are shown in the drawings are summarized below. These and other embodiments are more fully described in the Detailed Description section. It is to be understood, however, that there is no intend on to limit the invention to the forms described in this Summary of the Invention or in the Detailed Description. One skilled in the art can recognize that numerous modifications, equivalents, and alternative constructions exist, each that fall within the spirit and scope of the invention as expressed in the claims.

Generally, embodiments of the present invention include a system configured to provide the end user with the ability to make the luggage more or less compact, depending on the immediate needs of the person transporting the luggage. Those needs can include riding on a platform integrated with the luggage when necessary to travel long distances, and folding the system into a more compact form for storage in an overhead compartment or elsewhere.

In one illustrative embodiment of the present invention, the apparatus comprises a container configured to receive content such as apparel, a handle coupled to the container, and a platform with at least one wheel. The platform is rotatably coupled to the container at an edge proximal to the container such that, when rotated into a folded-down configuration, the platform is suitable for holding a standing person, and when rotated into a folded-up configuration, at least a portion of the platform is substantially in contact with the container.

In another illustrative embodiment of the present invention, the apparatus comprises a container configured to receive apparel, a handle coupled to the container, and a platform with at least one wheel. The platform is slidably coupled to the container and configured to slide from a closed position to an open position such that, when in an open position, the platform is capable of supporting a standing person.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a perspective view of a prior-art embodiment, according to an embodiment;

FIG. 2 is a perspective view of an embodiment of the present invention, including a fold-down platform, according to an embodiment;

FIG. 3 is a perspective view of an embodiment of the present invention, including a fold-down platform in a folded-up configuration, according to an embodiment;

FIG. 4 is a perspective view of an embodiment of the present invention, including a sliding platform in its open configuration, according to an embodiment;

FIG. 5 is a perspective view of an embodiment of the present invention, including a sliding platform in its closed configuration, according to an embodiment;

FIG. 6 is a perspective view of an embodiment of the present invention, including wheels that can fold, according to an embodiment;

FIG. 7, which includes FIGS. 7A, 7B, and 7C, is a perspective view of an embodiment of the present invention that includes a platform with a foldable wheel in various stages of folding, from fully unfolded in 7A to fully folded in 7C, according to an embodiment;

FIG. 8, which includes FIGS. 8A, 8B, and 8C, is a perspective view of an embodiment of the present invention that includes a platform with a foldable wheel in various stages of folding, from fully unfolded in FIG. 8A to fully folded in FIG. 8C, according to an embodiment; and

FIG. 9 is perspective view of an embodiment of the present invention, including a battery, motor, hand brake, and controls for automatically propelling the apparatus, according to an embodiment.

FIG. 10 is an exploded view of a foldable wheel assembly, according to an embodiment.

### DETAILED DESCRIPTION OF THE PREFERRED EMBODIMENT

One or more of the systems and apparatuses described herein describe a luggage transportation system. As used in this specification, the singular forms “a” “an” and “the” include plural referents unless the context clearly dictates otherwise.

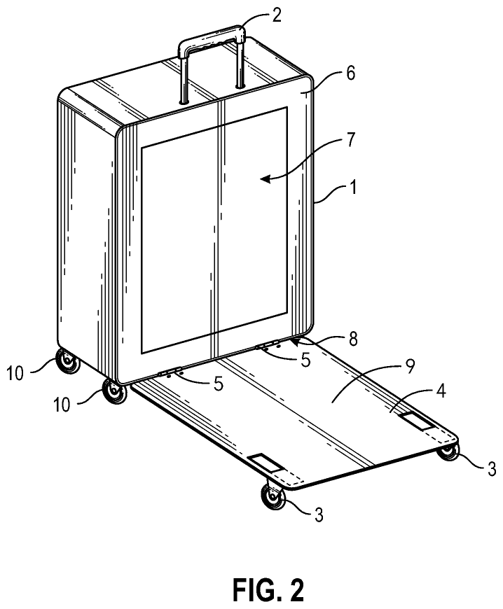

FIG. 2 is a perspective view of an embodiment of the present invention that includes container 1, which is a hollow body configured to hold clothing, apparel, or other articles or content, handle 2, body wheels 10, platform wheels 3, and platform 4. In an embodiment, container 1 is a suit case. Platform 4 includes an upper face 9 and is configured to support a standing person (including supporting such person's weight and size) as the luggage moves. Platform 4 is coupled to the container with one or more hinges 5, allowing platform 4 to be rotated around hinges 5 to fold up flush with, or substantially flush with, container 1. For the purposes of the present invention, the term hinge will be understood, in the context of platform 4 being connected to container 1, to mean any number of ways of connecting platform 4 to container 1, either directly or indirectly, such that proximal edge 8 of platform 4 is connected to container 1 in a way that allows platform 4 to rotate at proximal edge 8 up towards container 1 to be in a closed position, and away from container 1 to be in an open position. In one embodiment of the present invention, hinge (or hinges) 5 can be fabricated from metal, nylon, plastic, fabric, or any other material suitable for allowing platform 4 to fold and unfold. In an embodiment, platform 4 and body 1 form a unitary construction, while hinge 5 is a flexible material such as nylon. In another embodiment of the invention, edge 8 can be rounded or otherwise shaped such that it is connected to container 1 by a rod that is inserted through the rounded area of platform 4, and configured such that platform 4 is capable of rotating around the axis defined by such inserted rod. In any hinged embodiment, such hinges can be either external to or internal to container 1 and platform 4, provided that they allow platform 4 to fold up into a folded-up position, and fold down into a folded-down position. In another embodiment of the present invention, platform 4 can be fabricated integral to container 1 with the material of container 1 and platform 4 serving as the hinge. In this embodiment, the material of container 1 and platform 4 is sufficiently pliable to allow platform 4 to fold up into a folded-up position, and fold down into a folded-down position. In any of the embodiments represented by FIG. 2, container 1 can include face 6 that is flat and flush with the edges of the other sides of the container. In yet another embodiment of the present invention, container 1 is fabricated with indentation 7 such that, in its folded configuration, platform 3 fits into such indentation. In one embodiment of the invention, platform 4 can be made of steel, titanium, plastic, or any appropriate alloy or material sufficient to hold a user's weight. Platform 4 can include a non-skid surface such as textured metal, molded plastic, or grip tape.

In an embodiment, container 1 is configured with an opening (not shown) on the side of the container opposite the platform when the platform is in a folded-up position. In an embodiment, container 1 is configured with an opening on any practicable side of container 1.

In one embodiment of the invention, platform 4 can be opened and closed manually, can be spring activated, or can include an apparatus that allows a user to use a foot to open and close the platform. Alternatively, platform 4 can be opened and closed automatically, through a push button or other electrical switch located on the device.

Platform wheels 3 and body wheels 10 can be deployed in a variety of configurations, and can be made of materials such as polyurethane, metal, ceramic, or others. One skilled in the art will understand that platform wheels 3 and body wheels 10 can be positioned along the apparatus in any number of ways, including, from front to back, 2×2×2, 2×2×1, 2×1 in the back, or 1 in the front and 2 in the back. In one embodiment of the invention, platform wheels 3 and body wheels 10 are configured to be removed and replaced with wheels of the same size, or wheels of different size depending on speed requirements, terrain requirements, comfort level, ground surface material and/or incline, whether more or less friction or resistance to slip is required, whether the expected terrain (or unexpected terrain) is at an incline, or can be chosen based on weight requirements.

In any embodiment of the present invention, handle 2 is configured to fold or slide into container 1, thereby reducing the profile of the apparatus. In its folded-out or telescoped-out configuration, handle 2 can be configured to provide a static grip that allows a user a safe hand hold as the user stands on or leans on the platform while the luggage is moving. In one embodiment, handle 2 is in communication with one or more platform wheels 3 and body wheels 10, such that handle 2 can be turned or moved, allowing the user to steer the apparatus. In another embodiment, handle 2 is configured to be pumped either forward and backward, side to side, or up and down, thereby providing manual propulsion the system while a user stands on platform 4.

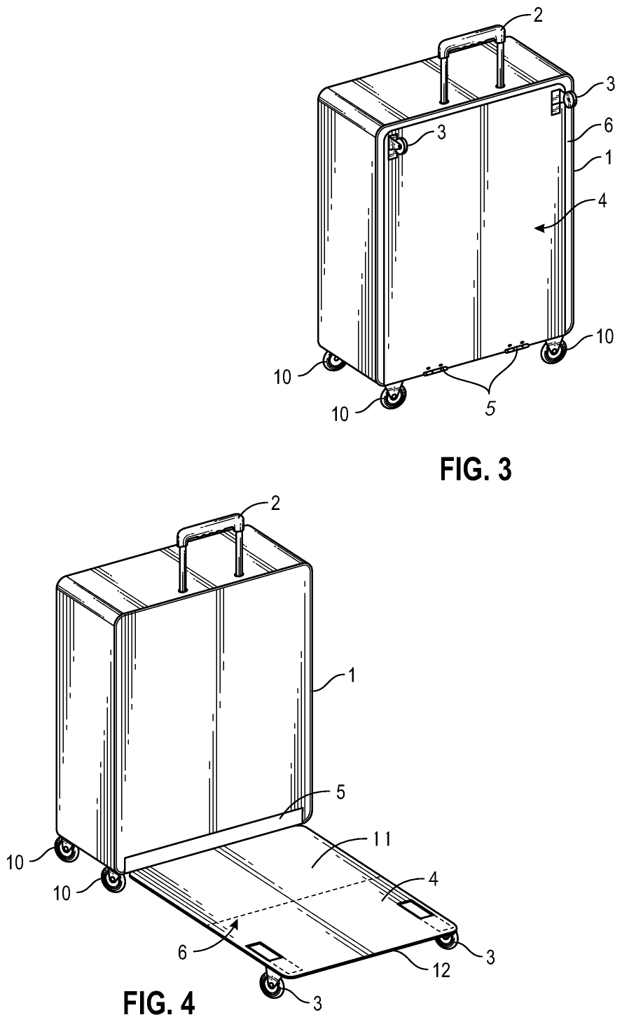

FIG. 3 is a perspective view of an embodiment of the present invention, including a platform 4 in a folded-up configuration. In this configuration, platform 4 is folded to be flush with, or substantially flush with, face 6. In one embodiment, platform wheels 3 are coupled to platform 4 in a way that allows them to be folded, removed, or otherwise moved to reduce the overall dimensions of the device. In an embodiment, when platform 4 is in the folded-down position, platform wheels 3 are moved into an open-wheel configuration to support platform 4; when platform 4 is in the folded-up position, platform wheels 3 are moved into a closed-wheel configuration to reduce the profile of the apparatus.

FIG. 4 is a perspective view of an embodiment of the present invention, including a sliding platform 4 in its open configuration. In this embodiment, platform 4 is coupled to or in communication with container 1 in such a way that allows platform 4 to slide at least in part into container 1 through groove 1 to create a closed configuration, and to slide out of container 1 to create an open configuration. In this embodiment, platform 4 is slidably coupled to container 1. For example, platform 4 may be configured to slide along tracks placed within container 1 through groove 5. Alternatively, platform 4 can be configured to slide along tracks external to container 1 (not shown).

In one embodiment of the present invention, platform 4 is a unitary piece and is dimensioned so that it can slide into a closed position such that its edges are substantially aligned with, or within, the edges of container 1. In another embodiment, and as shown in FIG. 4, platform 4 is divided into at least two pieces, proximal end 11 and distal end 12, that are connected via hinge 6. One skilled in the art will understand that hinge 6 can be a single hinge or multiple hinges provided that, once platform 4 is slid into the open configuration, it can be folded open at platform hinge or hinges 6 to increase its size, and folded closed at platform hinge or hinges 6 along a seam substantially perpendicular to the direction of sliding to decrease its size so more of the platform can be slid into groove 5.

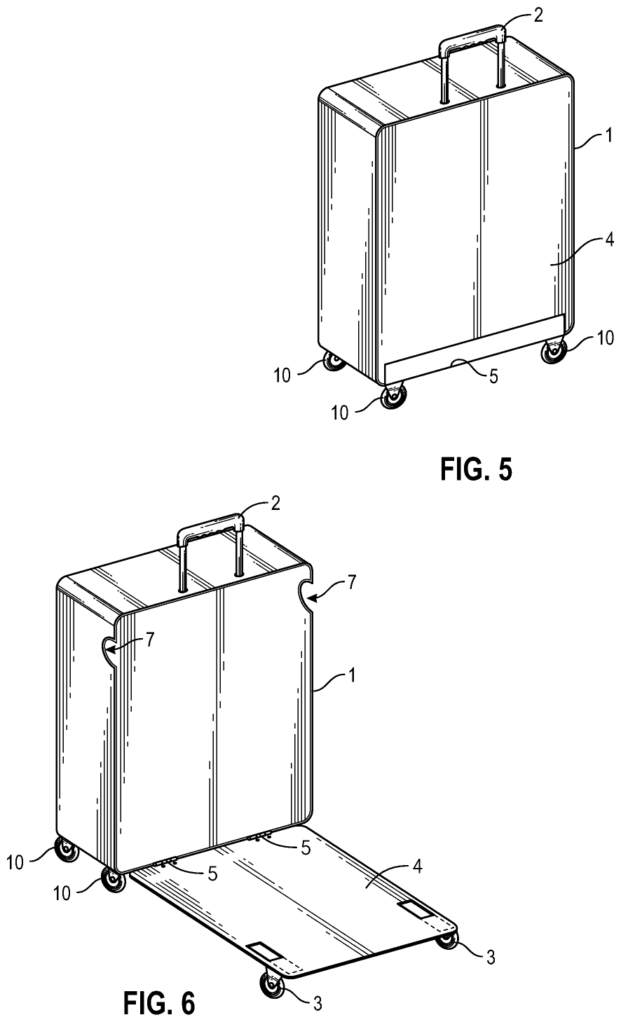

FIG. 5 is a perspective view of an embodiment of the present invention, including container 1, handle 2, wheels 3, platform 4, and groove 5, in which platform 4 has been slid into groove 5 located within housing 1 to create a closed configuration, thereby providing a smaller or reduced profile that allows the apparatus to be stored more compactly than if it was left in the open position, and is more convenient than if platform 4 had to be removed altogether, to reduce the size of container 1.

In another embodiment, platform 4 does not include wheels. Instead, platform 4 is coupled to or in communication with container 1 such that, in the open configuration, platform 4 is cantilevered or otherwise coupled to or in communication with container 1 in a way that allows platform 4 to provide support to a person standing on platform 4.

In some embodiments of the present invention, a user might find it desirable to either remove or fold the wheels, possibly motivated by a desire to reduce the overall profile of the device. FIG. 6 is a perspective view of an embodiment of the present invention, including container 1, handle 2, platform wheels 3, body wheels 10, platform 4, hinges 5, and foldable wheels 6. In this embodiment, foldable wheels are configured to fold, either up or down, to reduce the profile of platform 4 so that platform 4 can be folded along hinges 5 without leaving wheels protruding normal to the plane defined by platform 4. In an embodiment, platform wheels 3 are configured to be folded substantially flush with platform 4. In another embodiment of the present invention, container 1 includes cutouts or indentations 7. For the purposes of this invention, cutouts or indentations 7 will be referred to as indentations 7. These indentations 7 are placed on container 1, either by cutting into container 1, or molding container with the indentations in place, or otherwise manufacturing the device with indentations 7 in place. Indentations 7 are placed in a position where foldable wheels 6 can, when platform 4 is in its closed configuration, sit within or substantially within indentations 7, thereby reducing the overall profile of the device.

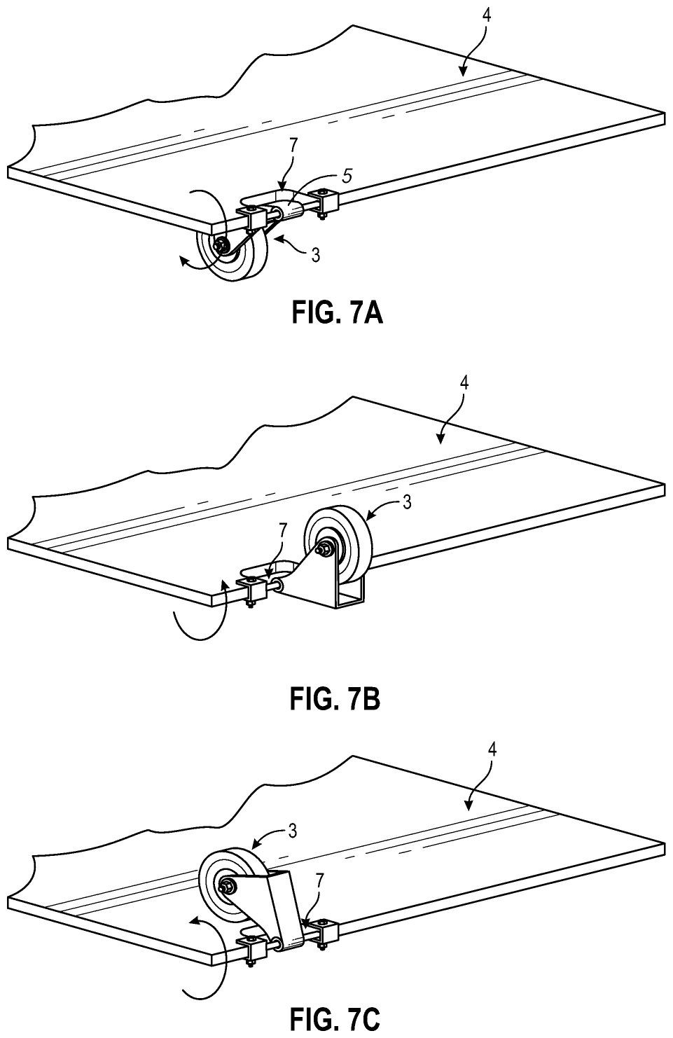

FIG. 7, which includes 7A, 7B, and 7C, is a perspective view of platform 4 with foldable platform wheels 3 in various stages of folding, according to an embodiment. In an embodiment, foldable platform wheel 3 can be coupled to platform 4 using hinge 5, or any housing or other coupling that connects foldable platform wheel 3 to platform 4. In 7A, foldable platform wheel 3 is coupled with or in communication with platform 4 in the open position. In 7B, foldable platform wheel 3 is in the midst of closing by swinging up and over the trailing edge of platform 4. In 7C, foldable platform wheel 3 has been folded upward into the folded configuration.

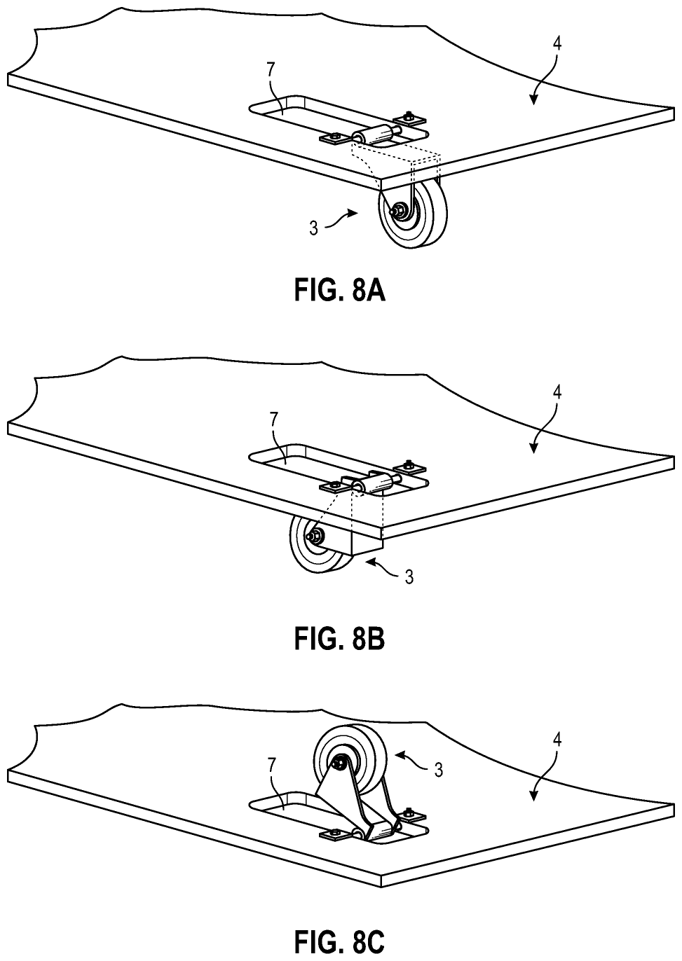

FIG. 8, which includes 8A, 8B, and 8C, is a perspective view of an embodiment of the present invention that includes platform 4 with a foldable platform wheel 3 in various stages of folding. In this embodiment, platform 4 includes cutout or indentation 7. For the purposes of the present invention, cutout or indentation 7 in FIG. 8 will be referred to as cutout 7. Cutout 7 is configured to receive foldable platform wheel 3 when foldable platform wheel 3 is in its folded position.

In 8A, platform 4 and foldable platform wheel 3 are in the open position. In 8B, foldable platform wheel 3 has begun to fold towards cutout or indentation 7. Finally, in 8C, foldable platform wheel 3 has been fully rotated to sit within cutout or indentation 7. Once foldable platform wheel 3 has been fully rotated, platform 4 can then be rotated upward to fold until it is flush with, or substantially flush with, the rest of the device (not shown in FIG. 8).

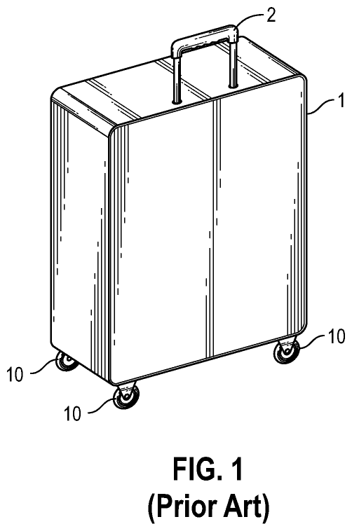

In an embodiment of the present invention, as represented by FIGS. 1-5, the apparatus can be moved by the user either through handle action, pushed with a hand, or propelled by foot. In one embodiment of the present invention, to stop, the apparatus can include a mechanically or electrically connected hand-operated brake or foot-operated brake (or both) that allows the user to activate such brake to stop or slow the apparatus when in motion, or to hold the apparatus in position when stopped.

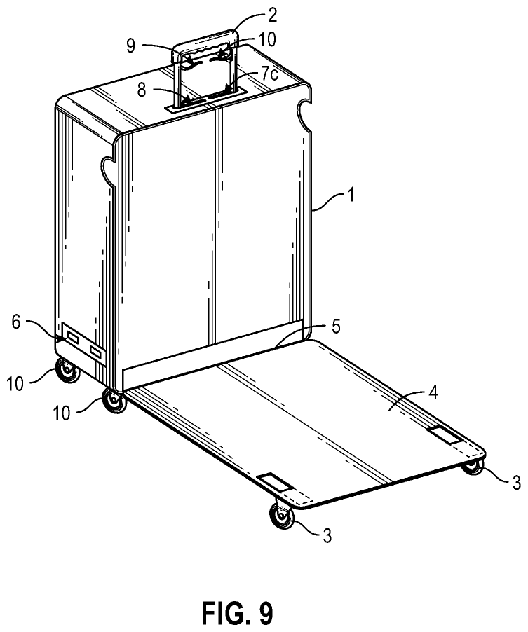

FIG. 9 is perspective view of an embodiment of the present invention, including a battery, motor, hand brake, and controls for automatically propelling the apparatus. In one embodiment of the present invention, container 1 is connected to platform 4, which may be slid into, telescoped, or folded to reduce the profile of the system. In one embodiment of the present invention, the system can be driven by a motor (not shown) that is powered by a battery 5. In an embodiment, the motor can be in communication with at least one driving wheel, which can be body wheel 10, which can be used to drive the apparatus forward, backward, or in any direction. In an embodiment, the driving wheel can be platform wheel 3, which can be used to drive the apparatus forward, backward, or in any direction. Battery 5 may be removable and/or rechargeable using charging mount 6. Charging mount 6 may contain a retractable cord for wall charging or USB charging. In another embodiment, charging mount 6 includes a USB port for charging the apparatus. Alternatively, the USB port can be used to power or charge a personal device such as a mobile telephone, a handheld tablet, a personal digital assistant, or any similar device.

In one embodiment of the present invention, battery 5 can be removed and replaced with a battery that provides more or less power to the apparatus, depending on a user's needs. For example, battery 5 can be chosen with power needs based on the desired speed of the apparatus, the travel distance desired, and the weight requirement of a user and the contents of the container. One skilled in the art will understand that battery 5 can be one or more nickel cadmium batteries, nickel metal hydride batteries, lithium ion batteries, lead acid batteries, or any practicable type of battery or batteries for driving the motor, provided such batteries fit the physical profile of the apparatus.

In one embodiment, battery 5 can drive a motor (not shown). Such a motor can be chosen for its size, its type, its torque, its power, and any number of factors that can be based on speed, distance, and weight requirements. One skilled in the art will understand that such a motor can be AC or DC, can be a brushless motor, a Hub motor, or any type of motor that is practicable for the desired use of the invention. In addition, one skilled in the art will understand that such a motor can be mounted in a variety of positions, including on an inner frame, an outer frame, or in a dedicated set of wheels.

In one embodiment of the invention, the container can include on/off switches 7, shown on the top of the container in FIG. 9, but can be placed anywhere practicable on the apparatus. In one embodiment, on/off switches 7 can be used to supply power from the battery to the rest of the system, and can be multiple switches, or a single toggle-type switch. In another embodiment of the present invention, on/off switches 7 can be positioned to as to allow for kick starting, or to be otherwise controlled by a user's foot or knee.

Other features not shown in the drawings can include sensors to adjust the speed of the apparatus, or to automatically brake the apparatus, for example, to avoid a collision, an audio warning in communication with the sensors to warn of obstacles or obstructions, a display to show charge level of battery 5, an odometer, a GPS device for keeping track of the apparatus, a GPS screen to provide directions to a user, and a GBPS interface.

In one embodiment of the invention, a throttle 8 can be placed on container 4 to control speed. As with on/off switch 7, throttle 8 can be placed anywhere practicable on the apparatus. Alternatively, the apparatus can include hand-controlled throttle 9. In one embodiment of the invention, hand-controlled throttle 9 can be coupled to handle 2 so as to be controlled by a user's hand as the user grips handle 2. One skilled in the art will understand that handle 2 can be located along the midline of container 1, or can be located closer to the user or farther from the user. Handle 2 can also be located further to the left or right of the midline of container 1. In one embodiment of the invention, throttle 8 or hand-controlled throttle 9 can be single speed throttles preconfigured to drive the apparatus at a predetermined or single speed. In another embodiment of the invention, throttle 8 or hand-controlled throttle 9 can be a variable-speed throttle that can increase or decrease speed through a continuum of speeds from zero miles per hour to a maximum speed. In yet another embodiment, throttle 8 or hand-controlled throttle 9 can increase or decrease the speed of the apparatus in discrete increments, such as five, ten, and twenty miles per hour.

To stop the apparatus, or to hold the apparatus in place while stationary, in an embodiment of the present invention, the apparatus includes hand-operated brake 10 coupled to handle 4. In an embodiment, the apparatus can include a foot brake (not shown) in communication with one or more of the wheels. In yet another embodiment, the device can be configured such that exiting platform 4 can cause the device to stop, or can cause the device to stop providing power to the wheels.

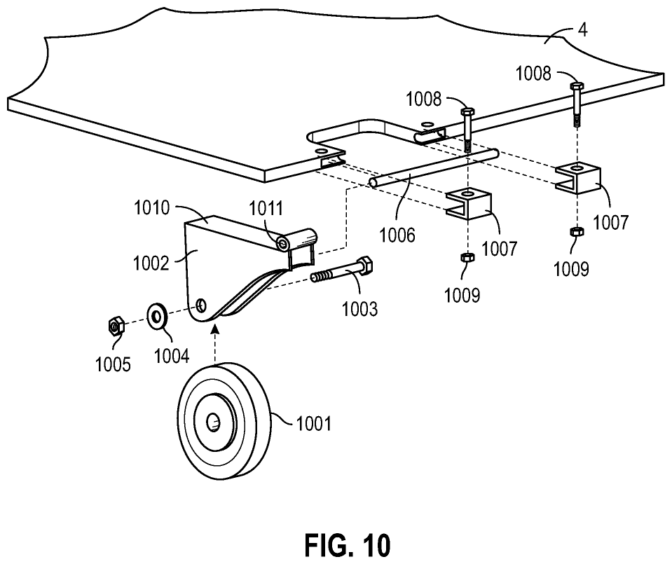

FIG. 10 is an exploded view of a foldable wheel assembly, according to an embodiment. In an embodiment, wheel 1001 is mounted on rotatable bracket 1002 using bearing 1003 that threads through washer 1004 and is secured by nut 1005. Bearing 1006 is secured to platform form, in an embodiment, using fixed brackets 1007, screws 1008, and nuts 1008. In an embodiment, rotatable bracket 1002 is configured to receive bearing 1006 through opening 1011, and to rotate around bearing 1006. In the open configuration, bracket top face 1010 of rotatable bracket 1002 rests against the bottom side of platform 4, preventing it from rotating further. In the closed configuration, rotatable bracket 1002 is rotated such that bracket top face 1010 is rotated away from the underside of platform 4.

One skilled in the art will understand that wheel 1001 can be attached to platform 4 in any practicable way that allows wheel to both roll as needed, and to fold as needed. In addition, wheels 1001 can be mounted to the bottom side of platform 4 via a swivel, allowing wheel 1001 to face in any desired direction, such that the platform can be more easily steered.

Although specific features of the invention are shown in some drawings and not in others, this is for convenience only as each feature may be combined with any or all of the other features in accordance with the invention. The words “including,” “comprising,” “having,” and “with,” as used herein, are to be interpreted broadly and comprehensively. Moreover, any embodiments disclosed in the subject application are not to be taken as the only possible embodiments.

I claim:

1. An apparatus, comprising:
a container configured to receive content;
at least one body wheel coupled to the container, a handle coupled to the container;
a platform movably coupled to the container and configured to move relative to the container from a closed position to an open position such that, in the open position, the platform is capable of holding a standing person.

2. The apparatus of claim 1, wherein the platform is rotatably coupled to the container.

3. The apparatus of claim 1, wherein the platform is slidably coupled to the container.

4. An apparatus, comprising:
a container configured to receive content; a handle coupled to the container;
a platform with an upper face and a proximal edge, the platform rotatably coupled to the container at the proximal edge such that, when rotated into a folded-down configuration, the upper face is suitable for holding a standing person, and when rotated into a folded-up configuration, at least a portion of the upper face is substantially in contact with the container;
at least one platform wheel coupled to the platform and configured to support the platform when the platform is rotated into the folded-down configuration.

5. The apparatus of claim 4, wherein the platform includes a hinged portion parallel to the proximal edge such that the platform is configured to fold along the hinged portion.

6. The apparatus of claim 4, further comprising at least one body wheel configured to support the container.

7. The apparatus of claim 4, further comprising a hand-operated brake.

8. The apparatus of claim 4, wherein the at least one platform wheel is coupled to the platform via a hinge that provides for an open-wheel configuration and a closed-wheel configuration.

9. The apparatus of claim 8, wherein the platform includes a cutout configured to receive the wheel when the wheel is placed in the closed-wheel configuration.

10. The apparatus of claim 4, further comprising:
at least one driving wheel coupled to at least one of the container and the platform, and wherein the motor is in communication with the at least one driving wheel and configured to drive the at least one driving wheel in at least one direction; and
a battery in electrical communication with the motor and configured to provide power to the motor.

11. The apparatus of claim 10, further comprising an on-off switch and a charging port for recharging the battery.

12. An apparatus, comprising:
a container configured to receive apparel; a handle coupled to the container;
a platform slidably coupled to the container and configured to slide from a closed position to an open position such that, when in an open position, the platform is capable of supporting a standing person; and
at least one platform wheel coupled to the platform and configured to support the platform when the platform is slid into the open configuration.

13. The apparatus of claim 12, wherein the container includes a front portion and a rear portion, and wherein the platform is configured to slide through an opening in the rear portion such that, when in a closed position, the platform is contained at least partially within the container.

14. The apparatus of claim 12, wherein the platform is configured to slide in a substantially horizontal direction along a track external to the container.

15. The apparatus of claim 12, wherein the platform includes a proximal end and a distal end, the proximal end being coupled to the distal end by at least one hinge substantially perpendicular to the direction the platform is configured to slide from the open position to the closed position.

16. The apparatus of claim 12, further comprising at least one body wheel coupled to the hollow body, and further comprising a motor in communication with the at least one body wheel.

17. The apparatus of claim 12, wherein the at least one platform wheel is coupled to the platform with a hinge that allows the wheel to fold substantially flush with the platform.

18. The apparatus of claim 17, wherein the platform includes a cutout configured to receive the wheel when the wheel is folded.

19. The apparatus of claim 12, further comprising a motor in communication with at least one of the at least one platform wheel and at least one body wheel, and configured to drive such wheel in at least one direction; and
a battery in electrical communication with the motor and configured to provide power to the motor.

20. The apparatus of claim 19, further comprising an on-off switch and a charging port for recharging the battery.
